(19) United States
(12) Patent Application Publication
(10) Pub. No.: US 2008/0236955 A1
(43) Pub. Date: Oct. 2, 2008

(54) EQUIPMENT AND METHOD FOR CONTROLLING AN ELEVATOR DOOR

(75) Inventors: Ari KATTAINEN, Hyvinkaa (FI); Matti Rasanen, Hyvinkaa (FI); Timo Laasonen, Hyvinkaa (FI)

Correspondence Address: BIRCH STEWART KOLASCH & BIRCH, PO BOX 747, FALLS CHURCH, VA, 22040-0747, US

(73) Assignee: KONE CORPORATION, Helsinki (FI)

(21) Appl. No.: 12/103,502

(22) Filed: Apr. 15, 2008

Related U.S. Application Data
(63) Continuation of application No. PCT/FI2006/000334, filed on Oct. 18, 2006.

(30) Foreign Application Priority Data
Nov. 24, 2005 (FI) 20051193

(51) Int. Cl. B66B 13/14

(52) U.S. Cl. 187/316

(57) ABSTRACT

An equipment (21) for controlling an elevator door (22) comprises a motor (24), an encoder (25) connected to the motor and a motor control unit (26), which are integrated into a coherent motor unit (23), an elevator control system (28), power supply means (29) for supplying operating power from the control system to the motor unit, and a data transfer bus (30) for data transfer between the control system and the motor unit. According to the invention, the data transfer bus (30) is bi-directional, and the motor unit (23) comprises a motor data storage unit (31).

### FIELD OF THE INVENTION

The present invention relates to an equipment and a method for controlling an elevator door.

### BACKGROUND OF THE INVENTION

The elevator door which moves together with the elevator car typically consists of one or two door leaves, which are moved by a so-called door operator. An essential component of the door operator is an electric motor producing a driving force which is used to move the door leaves in a desired manner. In addition, each floor is usually provided with separate landing doors. The landing doors, too, can be moved by the door operator in such manner that the opening or closing car door leaf also engages the landing door leaf.

The equipment controlling the elevator door usually additionally comprises a door control unit for controlling the door operator motor and an encoder arranged in conjunction with the motor shaft to provide feedback from the motor to the control unit. The control unit is used to control the operation of the motor, such as its starting, stopping, speed of rotation and other corresponding parameters. In practice, the control unit may be e.g. a circuit board provided with the power electronics components needed for electric control of the motor. The control unit again is controlled by the elevator control system, part of which control system may be disposed in conjunction with the elevator car. Via the control system, commands are issued regarding e.g. the instant of time of closing and opening of the door and the speed of motion of the door leaf, which commands are converted by the control unit into quantities required in the control of the motor, such as suitable voltage levels. The driving power to the control unit and motor is also supplied via the control system.

The above-described motor, control unit and control system portion disposed in conjunction with the elevator car are usually separate parts interconnected by cables as required. Such an equipment is laborious and expensive to install. Additional costs result from the large number of components. Moreover, this solution is not optimal when the space required by the parts outside the elevator car is to be minimized.

In functional respects, too, a conventional solution as described above has shortcomings. No feedback is usually provided from the motor to the control system. Therefore, the control system receives no information e.g. about the exact speeds and torques of the motor or in general about its operating history. On the other hand, in a typical system, no information regarding e.g. the floor at which the elevator is currently located can be transmitted to the control unit of the door operator motor. Therefore, if the landing doors on different floors differ in weight, the motor torque has to be designed according to the heaviest landing door, which is not the best possible solution in respect of efficiency. The separate motor and control electronics unit have to be calibrated with respect to each other during installation of the elevator to ensure that the motor operating parameters to be attained by the control are actually realized with a sufficient accuracy. This is important e.g. to ensure that the system will not exceed the maximum force allowed by safety regulations that the motor will exert to close the door leaf against a possible obstacle. Such calibration naturally increases the installation time and causes extra costs. In addition, each motor type requires a specific control electronics unit, which involves more complexity in the production process especially in the case of an extensive product range comprising many elevator systems of different types. Replacing a damaged motor and control electronics unit is a laborious task and often requires re-calibration of the control electronics unit at the site of installation of the elevator.

To facilitate installation of elevator door control equipment, patent specification EP1277689 proposes a control device in which a motor, an encoder and an electric control system as well as a number of potentiometers are integrated in the same frame. When installing the control device on different elevator doors, the installer adjusts the potentiometers to a position corresponding to the properties of the door in question. This obviates the need to adjust each part separately. However, this patent specification presents no solutions to the other functional shortcomings or problems referred to above.

### OBJECT OF THE INVENTION

The object of the present invention is to overcome the above-mentioned drawbacks.

A specific object of the invention is to disclose a new type of equipment for controlling elevator doors, an equipment that comprises only a few parts, is easy to install and maintain while enabling more flexible and accurate control of an elevator door than before.

A further object of the invention is to disclose a new method for controlling elevator doors, by which method an elevator door is controlled in a more flexible and accurate manner than before.

### BRIEF DESCRIPTION OF THE INVENTION

The equipment of the invention for controlling an elevator door is characterized by what is disclosed in claim 1. The method of the invention for controlling an elevator door is characterized by what is disclosed in claim 6. Other embodiments of the invention are characterized by what is disclosed in the other claims. Inventive embodiments are also presented in the description part and drawings of the present application. The inventive content disclosed in the application can also be defined in other ways than is done in the claims below. The inventive content may also consist of several separate inventions, especially if the invention is considered in the light of explicit or implicit sub-tasks or in respect of advantages or sets of advantages achieved. In this case, some of the attributes contained in the claims below may be superfluous from the point of view of separate inventive concepts. Within the framework of the basic concept of the invention, features of different embodiments of the invention can be applied in conjunction with other embodiments.

The equipment of the invention for controlling an elevator door comprises a motor, an encoder and a motor control unit, these parts being integrated into a coherent motor unit. Moreover, the equipment comprises an elevator control system, power supply means for supplying operating power from the control system to the motor unit, and a data transfer bus for data transfer between the control system and the motor unit. The motor may be any conventional electric motor used in corresponding applications. The encoder is connected to the motor shaft to collect information about the operation of the motor. The electric motor is operated by the control unit, which comprises power electronics providing electric control of the motor.

The motor unit integrated into a coherent assembly is installed in the elevator car in the immediate vicinity of the door mechanism of the elevator. The integrated motor unit allows space and cost savings due to a substantial reduction in cabling, among other things. The assembly consisting of a control unit, motor and gear system can also be calibrated beforehand during manufacture, thus saving time during installation and maintenance of the elevator and in connection with a possible motor change.

According to the invention, the data transfer bus is bi-directional. Unlike in prior-art solutions, by using a bi-directional data transfer bus, it is also possible for the control system to collect information about the operation and properties of the motor and the movements of the door. Thus, when generating the operating commands to be issued from the control system, the system can take the actual operation of the motor and door into account. In addition, as the operating history of the motor is known, it is possible to optimize e.g. the schedule of implementation of maintenance tasks.

Further according to the invention, the equipment comprises a unit for storing motor data. In this storage unit, it is possible to store e.g. characteristic data about the motor and the gear possibly associated with it, such as values of electric control parameters of the motor, information indicating the date of manufacture of the motor and gear or e.g. the highest torque sustained by the gear. These characteristic data can be read electrically into the control unit, so they can be taken into account in the control of the elevator door. A particularly significant advantage of this arrangement is that, as the motor, encoder, control unit and the storage unit containing the characteristic data are thus integrated into a single assembly, the same control system commands can be used to control several motor units of different types and consisting of different components. This allows different elevator system modules to be combined in very flexible ways when the elevator system is being designed. The storage unit may in practice be e.g. a memory element integrated in an electronics card of the control unit.

In an embodiment of the invention, the motor unit comprises a gear for converting the rotational speed of the motor shaft into a speed suited for the motion mechanism of the elevator door.

In a preferred embodiment of the invention, the data transfer bus comprises a serial communication bus. The serial communication bus can be implemented using only a two-wire cable, and thus, in addition to the data transfer function, it also allows the amount of cabling to be reduced as compared to prior-art solutions.

The data transfer bus may also comprise a wireless data transfer means for wireless transfer of data between the control system and the motor unit. This is a particularly effective solution as regards reduction of cabling.

In a preferred embodiment of the invention, a button for maintenance operation of the elevator door is integrated as part of the control system portion disposed in conjunction with the elevator car. In traditional solutions, maintenance operation buttons, which are needed for control of the elevator during a maintenance operation, are implemented as a part separate from the control system, connected to it via cables.

Integrating the button in the control system reduces cabling as well as the amount of separate parts required for door control. The button for maintenance operation of the elevator door as well as other maintenance operation buttons can be integrated e.g. directly on the electronics card in the control system portion placed on the top of the elevator car.

In the method of the invention, the characteristic data for the motor actuating the elevator door is stored in a motor data storage unit integrated in conjunction with the motor. Further according to the invention, a command for operating the elevator door is transmitted via a bi-directional data transfer bus from the elevator control system to a motor control unit integrated in conjunction with the motor, the operating command is converted in the control unit into a motor control signal corresponding to the characteristic data, operation data is generated by means of an encoder integrated in conjunction with the motor shaft and the operation data is transmitted from the control unit via the bi-directional data transfer bus to the elevator control system. The characteristic data may comprise e.g. motor performance values, information indicating the time of manufacture or e.g. the transmission ratio of a gear possibly connected to the motor and the maximum torque sustained by it. The characteristic data is preferably stored beforehand in the storage unit, e.g. already at the manufacturing stage. Thus it can be taken into account when an operating command coming from the control system is being converted into a motor control signal. As the control unit is integrated in conjunction with the motor, no separate control electronics is needed between the control system and the motor as in prior-art solutions. Together with the bi-directional data transfer bus, this allows, besides reducing the number of separate parts, more effective and versatile data transfer between the motor and the control system. From the point of view of the elevator manufacturer, the task of designing the door control system is simplified as the elevator control system can send target values related directly to door movements without having to know the properties of the various parts of the motor unit. Thus, the same operating commands can be used to control several motor units of different types. Utilizing operation data obtained from the motor, the control system can control the elevator doors in a more flexible and effective manner and more safely than before. The operation data transferred from the motor to the control system can be used to monitor e.g. the operating hours of the motor and thus to optimize the times for maintenance measures.

In an embodiment of the invention, the operating command and the operation data are transferred via a serial communication bus. A bi-directional data transfer bus can be implemented as a cable containing only two conductors, and thus the use of such a bus contributes towards reducing the amount of cabling required.

The amount of cabling is most effectively reduced in an embodiment of the invention where the operating command and the operation data are transmitted over a wireless communication bus.

The operating command preferably comprises a target value for the speed of the elevator door. In this case, the same operating command is applicable for different types of combinations of motor and gear and door motion mechanism. The required information for converting the target value into a motor control signal can be obtained e.g. from the data stored in the storage unit. In addition to the characteristic data for the motor, these data may include various information about the door motion mechanism.

The operating command may also comprise a maximum allowed value for the force applied to close the elevator door. Such a guide value related to user safety is generally prescribed in official regulations concerning elevators.

The operating command preferably also comprises data indicating the position of the elevator car. In a case where the elevator door also engages the landing door on the landing floor, the motor control signal can be optimized according to the mass of the door on the floor in question. The mass data may be stored in the control unit or in the storage unit.

The operation data received by the control unit as feedback from the motor preferably comprises data indicating the speed of the elevator door. In this context, speed refers both to the instantaneous speed value and to the change of speed, i.e. acceleration. By utilizing speed data indicating the realized speed, it is possible for the control system to calculate e.g. the exact position of the door at each instant and to optimize the subsequent operating commands on the basis of this. As the mass of the door to be moved is known, the kinetic energy of the door can also be calculated on the basis of the speed and compared to the maximum value consistent with safety regulations.

The operation data may also comprise data indicating the force to be used in moving the elevator door. This can be e.g. compared to the maximum allowed closing force consistent with the operating command and the target value of the speed can be changed if necessary.

In an embodiment of the invention, one or more data items comprised in the operation data of the motor are stored in the motor data storage unit. Thus, the operating history accumulated in the motor unit relating to the motor and the gear possibly associated with it can be read into the control system via the communication bus if necessary, allowing e.g. maintenance times to be optimized.

### LIST OF FIGURES

In the following, the invention will be described in detail by referring to a few embodiment examples and the attached drawings, wherein

FIG. 1 presents a prior-art equipment for controlling an elevator door,

FIG. 2 presents an elevator door control equipment according to the invention, and

FIG. 3 represents a method according to the invention.

### DETAILED DESCRIPTION OF THE INVENTION

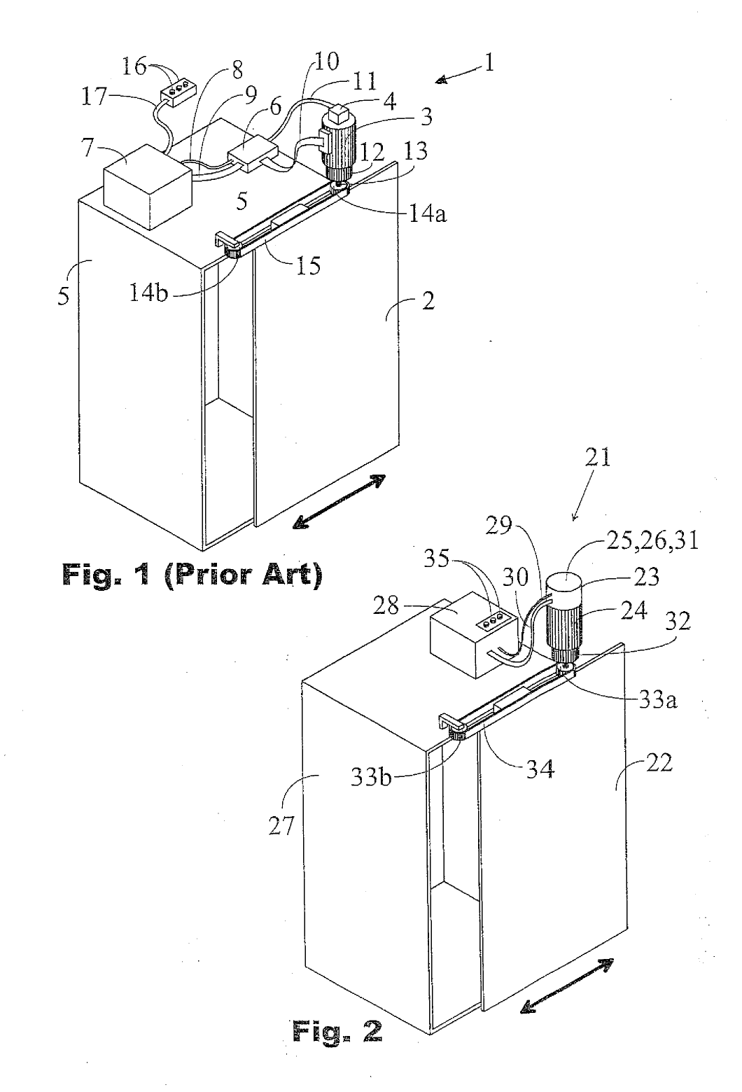

The prior-art equipment 1 for controlling an elevator door 2 as presented in FIG. 1 comprises a motor 3, an encoder 4 connected to it and a motor control electronics unit 6 placed on the top of the elevator car 5. Moreover, the equipment comprises an elevator control system portion 7 disposed on the top of the elevator car. Connected between the elevator car top portion 7 of the control system and the control electronics unit 6 is a power supply cable 8 and a serial data communication cable 9. Connected between the control unit 6 and the motor 3 is a signal cable 10 for the transmission of motor control signals. In addition, the encoder 4 is connected by a feedback cable 11 to the control electronics unit 6 for the transmission of feedback signals from the motor to the control electronics unit. Coupled to the motor is a gear 12, which has an output shaft 13 with a first cogwheel 14a mounted on it. A corresponding second cogwheel 14b is rotatably mounted on the top of the elevator car 5. Mounted around the cogwheels is a cogged belt 15. The elevator door 2 is arranged to be engaged with the cogged belt 15 in such manner that, when the motor is rotating the first gear wheel 14a and therefore the cogged belt 15, the door 2 moves with the cogged belt 15 to the open or closed position, depending on the direction of rotation of the motor. The figure also shows maintenance operation buttons 16 of the elevator, which are connected by wires 17 to the control system 7. Using the maintenance operation buttons, the elevator can be operated and its doors can be opened and closed from the top of the elevator car 5. It can be seen from the figure that the prior-art solution has numerous bulky components and a large amount of cabling placed on the top of the elevator car. In addition, as the control unit 6 and the motor 3 are components separate from each other, each combination of control unit and motor has to be calibrated with respect to each other during installation of the elevator. Besides, no direct feedback is provided from the motor 3 to the elevator control system 7, and thus collecting information about the operation of the motor is difficult.

As compared to prior-art solutions, the equipment 21 presented in FIG. 2 contains considerably fewer separate parts and cable connections. The equipment 21 for controlling an elevator door 22 comprises a motor unit 23, in which a motor 24, an encoder 25 connected to the motor and a motor control unit 26 are integrated into a single assembly. In the figure, the encoder 25 connected to the motor shaft and the electric control unit 26 are hidden inside the housing of the motor unit 23. Placed in conjunction with the elevator car 27, preferably on its top, is a portion 28 of the elevator control system, which may comprise electronics performing different functions. Connected between the control system portion 28 and the motor unit are a power supply cable 29 as well as a serial communication cable 30 for bi-directional data transfer between the control system portion and the motor unit. In addition, the motor unit comprises as an essential element a motor data storage unit 31, which in the figure is likewise hidden inside the housing of the motor unit 23. In practice, the storage unit may be an integrated part of the electronics of the control unit. Connected to the motor is a gear 32. The motion mechanism of the elevator door comprises a first cogwheel 33a connected to the axle of the gear 32, a second cogwheel 33b mounted on the elevator car at a distance from the first cogwheel, and a cogged belt 34 mounted around the cogwheels 33a, 33b. The elevator door 22 is arranged to be engaged with the cogged belt 34 in such manner that, when the cogged belt is moving, the door 2 moves to the open or closed position, depending on the direction of rotation of the motor 24. Integrated in the elevator control system portion 28 disposed on the top of the elevator car are buttons 35 for maintenance operation of the elevator, allowing e.g. the elevator door to be opened during a maintenance operation. Unlike in the case of traditional separate maintenance operation buttons wired to the control system, the buttons can be connected directly to a circuit card in the control system portion 28, thus reducing material costs and simplifying manufacture of the equipment. In addition to reducing the number of separate parts, the control equipment presented in FIG. 2 enables an elevator control method that is considerably more flexible and versatile than earlier methods. The control unit being integrated as part of the motor unit allows, among other things, the same operating commands of the control system to be used to control several motor units of different types. The storage unit enables an electric label function wherein all the essential properties of the motor unit can be stored in electric form, to be read by the storage unit or control system as required. Likewise, it is possible to continuously save data about the operating history of the motor unit to the storage unit.

For the sake of simplicity, many details inessential to the invention, such as the securing of the motor or the connections between the control system portion disposed on the top of the elevator car and other parts of the control system, are omitted from FIGS. 1 and 2. Also, the door motion mechanism is presented in a simplified form. Moreover, the figures show only one door leaf, but in practice the door often consists of two door leaves moving in opposite directions.

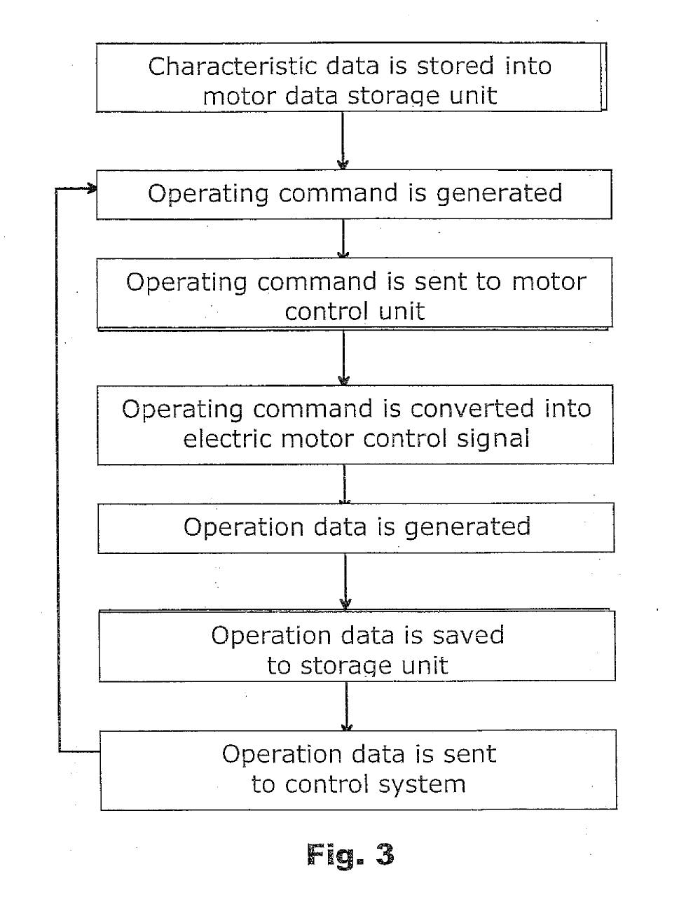

FIG. 3 visualizes the method of the invention by presenting some of the steps comprised in the elevator door control method. In a first step, the characteristic data is stored beforehand, preferably already at the manufacturing stage of the integrated motor unit, in the motor data storage unit integrated in conjunction with the motor. One of the characteristic data items may be e.g. the transmission ratio of the gear connected to the motor. Information about other parts having an influence on the ratio between the rotational speed of the motor and the speed of motion of the door can likewise be stored beforehand. When the elevator control system detects, e.g. when the elevator is arriving at a floor, that the elevator door should be actuated, an operating command is generated in the control system and transmitted to the control unit of the integrated motor unit. The operating command may include e.g. a first target value of door speed. The target door speed value may be based on a predetermined speed profile in which the door speed is defined as increasing with a given acceleration until a maximum speed is reached, and in which profile the speed is finally decreased in a corresponding manner with a given deceleration as the door is approaching the end of its path. The operating command may additionally comprise e.g. data indicating the mass of the landing door on the floor in question if the landing door is moved together with the elevator door. The operating command is converted in the control unit into an electric motor control signal taking into account the characteristic data, e.g. transmission ratio of the gear, stored in the storage unit. When the motor is in operation, the encoder connected to the motor shaft produces operation data, which may contain e.g. information indicating the actual speed of motion of the elevator door and the rotational speed of the motor. Next, for example, the operation data containing the rotational speed of the motor is stored into the storage unit. This makes it possible to monitor the operating history of the motor. Next, the operation data containing e.g. the door speed is transmitted via the bi-directional data transfer bus to the control system. In this way, the system is informed of any possible deviation of the speed from the target, which may be due e.g. to an obstacle on the path of the door or to dirt in the door motion mechanism. The instantaneous position of the elevator door can be calculated in the control system on the basis of the actual speed. This is taken into account in the generation of the next operating command containing a target speed value. In this manner, the exchange of operating commands and operation data respectively between the control system and motor unit is continued until the door has moved to the desired position.

The invention is not exclusively limited to the above-described embodiment examples, but many variations are possible within the scope of the inventive concept defined in the claims.

1. Equipment (21) for controlling an elevator door (22), said equipment comprising a motor (24), an encoder (25) connected to the motor and a motor control unit (26), which are integrated into a coherent motor unit (23), an elevator control system portion (28) disposed in conjunction with the elevator car (27), power supply means (29) for supplying operating power from the control system to the motor unit, and a data transfer bus (30) for data transfer between the control system and the motor unit, characterized in that the data transfer bus (30) is bi-directional and the motor unit (23) comprises a motor data storage unit (31).

2. Equipment (21) according to claim 1, characterized in that the motor unit (23) comprises a gear (32) for converting the speed of rotation of the motor (24) into a speed suited for the motion mechanism (33a-b, 34) of the elevator door (22).

3. Equipment (21) according to claim 1 or 2, characterized in that the data transfer bus comprises a serial communication bus (30).

4. Equipment (21) according to claim 1 or 2, characterized in that the serial communication bus comprises a wireless data transfer means.

5. Equipment (21) according to claim 1, characterized in that a button (35) for maintenance operation of the elevator is integrated as part of the control system portion (28) disposed in conjunction with the elevator car.

6. Method for controlling an elevator door (22), characterized in that
characteristic data of the motor (24) actuating the elevator door (22) is stored in a motor data storage unit (31) integrated in conjunction with the motor,
a command for operating the elevator door (22) is transmitted via a bi-directional data transfer bus (30) from an elevator control system portion (28) disposed in conjunction with the elevator car (27) to a motor control unit (26) integrated in conjunction with the motor (24),
the operating command is converted in the control unit (26) into a motor (24) control signal corresponding to the characteristic data,
operation data is generated by means of an encoder (25) integrated in conjunction with the motor (24), and
the operation data is transmitted from the control unit (26) via the bi-directional data transfer bus (30) to the said elevator control system portion (28).

7. Method according to claim 6, characterized in that the operating command and the operation data are transmitted via a serial communication bus (30).

8. Method according to claim 6, characterized in that the operating command and the operation data are transmitted via a wireless communication bus.

9. Method according to any one of claims 6-8, characterized in that the operating command comprises a target value for the speed of the elevator door (22).

10. Method according to claim 6, characterized in that the operating command comprises a maximum allowed value for the force closing the elevator door (22).

11. Method according to claim 6, characterized in that the operating command comprises data indicating the position of the elevator car (27).

12. Method according to claim 6, characterized in that the operation data comprises data indicating the speed of the elevator door (22).

13. Method according to claim 6, characterized in that the operation data comprises data indicating the force applied to move the elevator door (22).

14. Method according to claim 6, characterized in that one or more data items comprised in the operation of the motor (24) are stored into the motor data storage unit (31).
